(19) United States
(12) Patent Application Publication
(10) Pub. No.: US 2011/0226043 A1
(43) Pub. Date: Sep. 22, 2011

(54) REFERENCE LEAKAGE DEVICE FOR LEAK CALIBRATION

(76) Inventors: Giuseppe FIrpo, Genova (IT); Luca Repetto, Genova (IT); Ugo Valbusa, Genova (IT)

(21) Appl. No.: 13/119,553

(22) PCT Filed: Sep. 16, 2009
(86) PCT No.: PCT/IB2009/054039

§ 371 Date: Jun. 13, 2011

(30) Foreign Application Priority Data
Sep. 18, 2008 (IT) TO2008A000683

(51) Int. Cl. G01M 3/04; B23K 15/08

(52) U.S. Cl. 73/40; 219/121.18

(57) ABSTRACT

Reference leakage device (1) for use in leakage detection of gas, comprises a membrane (5) adapted to be interposed between two environments having respective pressures pu and pa, where (I). The membrane has an orifice (6) adapted to determine a controlled gas flow depending on the pressure pᵤ. The orifice has a preset diameter D and length L such that (II). The diameter D and the length L are further dimensioned in such a manner that the equivalent diameter De of the orifice is Dₑ≦100 nm, where Dₑ is defined by the relation Dₑ=D.a^{1/2} wherein a is the transmission probability of the orifice, function of the L/D ratio. The orifice is adapted to operate in molecular flow regime in an entire range of pυ values comprising the value of atmospheric pressure.

The present invention relates to a reference leakage device for use in leak detection of gas, said device comprising a membrane adapted to be interposed between two environments having respective pressures pᵤ and p_{d}, where pᵤ>>p_{d}, wherein said membrane has an orifice adapted to determine a controlled gas flow depending on the pressure pᵤ, said orifice having a preset diameter D and length L.

Devices of this kind enable gas controlled flows to be generated and leak values to be estimated by calibrating the instruments necessary for the detection thereof during leak tests.

The currently used devices are substantially of two kinds: orifice leaks, or capillary, and helium permeation leaks.

The first ones, also called pinholes, are generally made by laser ablation or chemical etching. Such technologies enable apertures to be manufactured with high precision and reproducibility up to a minimum diameter of 1 μm. This impedes to reach low flow values which, on the other hand, are obtainable by the permeation leaks.

An example of such orifice leaks is described in US 2006/0144120.

However, the orifice leaks of the known-type are very susceptible to partial or complete closure (clogging) due to different kinds of pollutants. These pollutants are often introduced into the device; due to the device exposure to air or the oil backflow of mechanical pumps used for vacuum generation, and are carried to the orifice into which they can be trapped (solid pollutants) or condensed (liquid or vapour pollutants), thereby reducing the dimension of the area available for the gas flow.

The permeation leaks have, on the other hand, a very unstable behaviour when the temperature changes (their value varies of about 3% per centigrade grade in case of temperatures values around room temperature), have long response times, are fragile (being made of glass, they are easily breakable even when they only fall to the ground), are only available for helium, and have a single flow value.

Examples of such permeation leaks are described in DE 195 21 275 and WO 02/03057.

The object of the present invention is to provide a leakage reference device which is able to compensate for the drawbacks of the prior art.

This and other objects are achieved by a device of the above-defined kind, wherein the diameter D and the length L are further dimensioned in such a manner that the equivalent diameter Dₑ of the orifice is Dₑ≦100 nm, where Dₑ is defined by the relation Dₑ=D·(a)^{1/2} wherein a is the transmission probability of the orifice, function of the L/D ratio, said orifice being adapted to operate in molecular flow regime in an entire range of pᵤ values comprising the value of atmospheric pressure.

Compared to permeation leaks, the device according to the invention has a much more stable behaviour when the temperature changes, can be used for any kind of gas (including mixtures), and can calibrate all the flow values in a determined range by merely varying the pressure at its inlet.

The device according to the invention is based on the same principle of physics applied in the orifice leaks. However, compared to the conventional leaks of this kind, it permits to calibrate much lower gas flow ranges, and the tendency to get clogged is considerably reduced.

It is a further object of the invention a method for manufacturing a reference leakage device, the feature thereof are defined in claim 5.

Particular embodiments are the object of the dependant claims, the subject-matter thereof is to be intended to be integral part of the present description.

Further features and advantages of the invention will be apparent from the detailed description below, given by pure way of non-limiting example, with reference to the appended drawings, wherein:

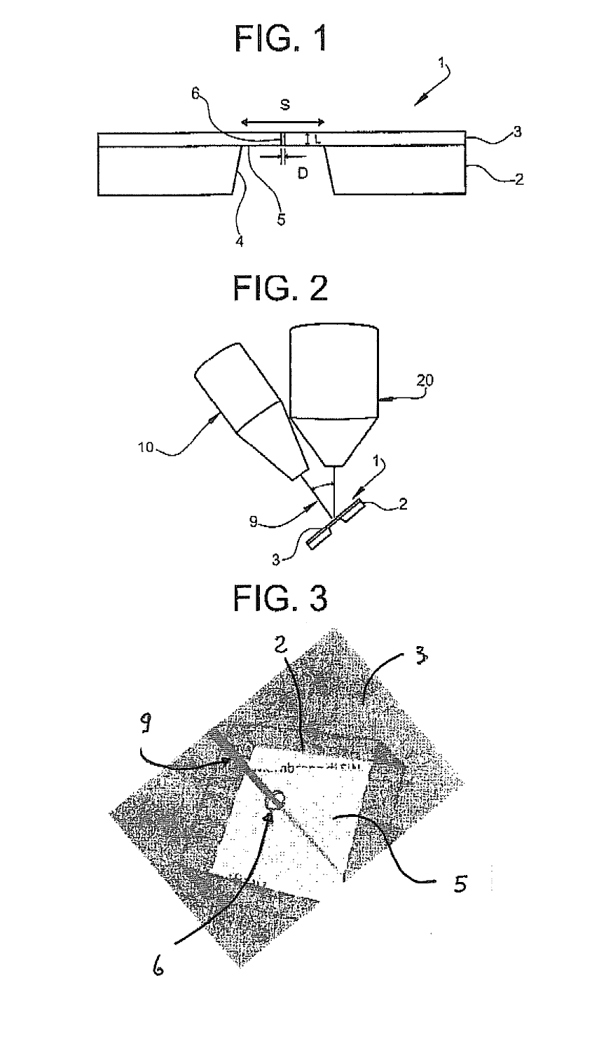

FIG. 1 is a sectional simplified view of a reference leakage device according to the invention;

FIG. 2 is a schematic view of a manufacturing step of the device of FIG. 1;

FIG. 3 is a perspective enlarged view of a detail of the device during the manufacturing step of FIG. 2;

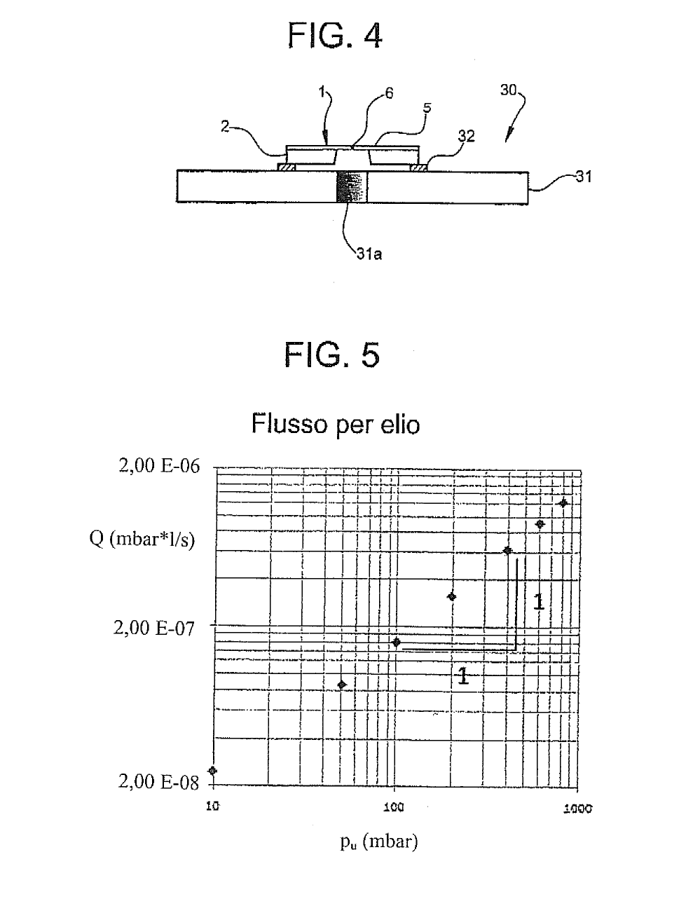

FIG. 4 is a sectional simplified view of the device of FIG. 1 mounted on a support disc having bores; and

FIG. 5 is a chart showing the helium flow curve as a function of the pressure through a device according to the invention.

FIG. 1 illustrates an example of a reference leakage device according to the invention, which is denoted 1 as a whole. Such device 1 comprises a bearing substrate 2 and a membrane layer 3. In the substrate 2 a through bore 4 is made, above which a portion of the membrane layer 3, i.e. the real membrane 5, is suspended. Such membrane 5 has therefore a transverse dimension S (diameter or side) defined by the transverse dimensions and shape of the through bore 4. Structures having a membrane and a support of this kind are, for instance, the ones which consist of a silicon nitride membrane on a silicon substrate and marketed by SPI Supplies, West Chester, Pa., USA. However, the kind of structure is not essential for the invention, as long as it contains a membrane. For example, the structure could consist of one plate made in a single piece, wherein the membrane is obtained by making the plate thinner at its central zone.

The membrane dimensions, with regards to its thickness, have to be appropriate so as to make the membrane to bear a pressure difference of 1 atmosphere without breaking.

In the membrane 5 is made at least one orifice 6 having a diameter D and a length L which are preset so that L<20·D. Such condition corresponds to the conventional definition of the so-called “short tube” (Bruno Ferrario, “Introduzione alla Tecnologia del Vuoto” seconda edizione riveduta ed ampliata da Anita Calcatelli (1999), Patron Editore—Bologna, page 85). The value of the length L of the orifice 6 obviously coincides with the one of the thickness of the membrane 5.

The conductance in molecular flow of a short tube is expressed by the following relation (John F. O'Hanlon, “A user's guide to vacuum technology” second edition (1989), John Wiley & Sons, pages 34-35):

C_{short tube}=a×Cₐₚₑᵣₜᵤᵣₑ (1)

where:

C_{short tube} is the conductance in molecular flow of the short tube,

Cₐₚₑᵣₜᵤᵣₑ is the conductance in molecular flow of an aperture (conventionally defined as an orifice having L=0) having a cross-section equal to the one of the short tube,

a is the transmission probability of the short tube, function of the L/D ratio.

In the past the function a has been a research subject and its values depending on the variation of L/D have been precisely defined (John F. O'Hanlon, “A user's guide to vacuum technology” second edition (1989), John Wiley & Sons; P. Clausing, Ann. Physik (5) 12, 961 (1932), English translation in J. Vac. Sci. Technol. 8, 636 (1971); W. C. DeMarcus, Union Carbide Corp. Report K-1302, part 3, 1957; A. S. Berman, J. Appl. Phys., 36, 3356 (1965), and erratum, ibid, 37, 4598 (1966); R. J. Cole, Rarefied Gas Dynamics, 51 Part 1, of Progress in Astronautics and Aeronautics, ed. J. L. Potter, (10^{th} Int'l Symp. Rarefied Gas Dynamics), Am. Inst. Of Aeronautics and Astronautics, 1976, p. 261).

It is known that the conductance of an aperture is:

Cₐₚₑᵣₜᵤᵣₑ=11.6×A (l/s) (2)

where A, expressed in cm², is the area of the aperture.

Conventionally, the equivalent diameter Dₑ of a short tube having a diameter D is defined as the diameter of an aperture which has the same conductance in molecular flow regime of the short tube having diameter D. Taking into account the relations (1) and (2), the equivalent diameter Dₑ is related to the diameter D by the following:

D=Dₐ/\sqrt{a}

According to the invention, the length L and the diameter D of the orifice are dimensioned in such a manner that the equivalent diameter Dₑ, defined by the relation Dₑ=D·(a)^{1/2}, is Dₑ≦100 nm. Such condition is essential for, the reasons which will be made clear hereinafter.

Preferably, the membrane 5 is made up of ceramic, metallic, semiconductor material or a combination of such materials, and the orifice 6 is obtained through milling by means of a highly focused ion beam, commonly named by the acronym FIB.

In this case, the structure comprising the membrane 5 is inserted into a vacuum chamber (not shown), in which it is positioned so as to be orthogonally hit by a focused ion beam 9, as shown in FIG. 2. Such beam 9 is generated by an FIB generating unit 10. The beam 9 produces a hole (the orifice 6) in the membrane 5, as shown in FIG. 3.

In particular, the inventors used an apparatus comprising an FIB generating unit 10 coupled to a scanning electron microscope (SEM) unit, denoted 20 in FIG. 2, The dimensions of the ion beam used, of about 10 nm, allow to reproducibly make bores having a minimum diameter of 30 nm, depending on how long and how the membrane-carrying structure is exposed to the ion beam, and depending on how thick the membrane is. The concurrent presence of the SEM unit allow to monitor the processing, therefore improving the precision (the resolution of the SEM used is about 1 nm), the cleanliness, and the manufacturing time reduction, since it is not necessary to transfer the manufactured sample to another place in order to measure the FIB processing dimension.

The device 1, for instance made as described above, is adapted to be interposed between two environments having respective pressures pᵤ, and p_{d}, where pᵤ>>p_{d}. For instance, this can be achieved by mounting in fluid-tight manner the device 1 on a copper disc provided with holes and having dimensions compatible for the use with ultra high vacuum (UHV) flanges. For the sake of conciseness, it will be hereinafter made reference to this specific arrangement, which will be called “leakage assembly”.

FIG. 4 illustrates such leakage assembly which is denoted 30 as a whole and consisting of a disc 31 having a hole 31a onto which the device 1 is mounted in a fluid-tight manner by a sealing adhesive 32. The use of an adhesive is not essential, since alternative solutions are conceivable, such as brazing (Development of Electron Guns for Excimer Light Sources in the Vacuum UV, R. Steinhuebl, K. Besenthal, N. Koch e G. Knorfeld, IEEE Transactions on Electron Devices, Vol. 52, No. 5, May 2005). The installation on a UHV-compatible disc is not essential as well, since other leakage assembly structures are conceivable. The necessary condition is that once the whole leakage assembly (to be intended as the group composed of the device 1 and the support onto which the device is installed) has been mounted in a vacuum system, it assures a fluid-tightness which has the lowest possible leak compared to the minimum flow value for which the device 1 is designed. For example, an adequate value for such leak could be a tenth of the planned minimum flow.

For a proper use, the leakage assembly 31 has to be mounted in such a manner to have the higher pressure value pᵤ located on the side where the device 1 is located. This is to reduce the probability that the device 1 could break.

The other side of the assembly 31 always remains exposed to vacuum, with a pressure p_{d} which for the sake of simplicity can always be considered <10⁻⁵ mbar. On the side of the device 1, the pressure is raised from a lower value, for example 10⁻² mbar, up to about 1000 mbar (atmospheric pressure), by making enter the desired gas in order to test the device. The lower end reached by pᵤ determines the degree of purity of the gas with which the device is tested. When pᵤ changes, the gas flow directed to the side having pressure p_{d} changes according to the relation:

Q=C×(pᵤ−p_{d}),

where Q is the flow and C is the conductance of the leakage assembly 31. The conductance depends on the geometric dimension and the shape of the leakage assembly 31, and in particular it depends on the ones of the orifice 6.

The dimensions L and D of such aperture 6 are so that, in the entire operating range, from pᵤ<10⁻² mbar to pᵤ=1000 mbar, the flow regime continues to be molecular, and this means that the flow Q linearly depends on the pressure difference (C independent of the pressure), or simply on pᵤ since pᵤ>>p_{d}.

Surprisingly, it has been found that, for orifice equivalent diameters Dₑ≦100 nm, the tendency to get closed (clogging) due to a possible contamination is dramatically reduced. To the inventors' knowledge, such an effect was never reported in literature.

As a further result, it is possible to reach very low flows having an order of magnitude of 10⁻⁸ mbar*litre/s (for helium gas, which then corresponds to the flow values of the permeation leaks).

The inventors made a prototype having a silicon nitride membrane on a silicon substrate, with the construction shown in FIG. 4. The features of the device were the following:
membrane thickness (coinciding with the length L of the orifice): L=1 μm
orifice diameter: D˜200 nm (and thus Dₑ˜87 nm);
membrane shape and dimensions: square whose side is 300 μm
copper disc compatible with a 16NW-Conflat® UHV flange
sealing adhesive: epoxy resin Stycast® 2850 FT.

Tests demonstrating the operation of the device structured as above can be summarized in the chart of FIG. 5, where the meaning of Q and pᵤ is the one previously indicated. In such chart, the linear operation of the device is clearly visible.

Moreover other prototypes were successfully made:
square SiN membranes whose thickness was 200 nm and whose side was 500 μm, wherein the obtained orifice had a diameter shorter than 200 nm (about 170 nm),
membrane having a side of 200 μm and made in a silicon plate whose thickness were 2 μm, wherein the orifice had a diameter of 200 nm and a length of 700 nm.

The above prototypes did not exhibit any remarkable clogging problems.

During the tests, on the other hand, it has been verified that orifices having dimensions L and D falling into the viscous flow regime in atmospheric pressure, for example D=500 nm and L=200 nm, almost systematically close.

Therefore, if one wishes to achieve higher flows with the same pressure difference while remaining in the molecular flow regime, according to the invention it is possible to conceive of providing a plurality of orifices in the membrane, each orifice having the necessary features for L and D.

Naturally, the principle of the invention remaining the same, the embodiments and constructional details may be widely varied with respect to what have been described and illustrated, purely by way of a non-limiting example, without thereby departing from the scope of the invention as defined in the accompanying claims

1. A reference leakage device for use in leakage detection of gas, the device comprising: a membrane adapted to be interposed between two environments having respective pressures pᵤ and pa, where pᵤ [symbol] p_{d}, the membrane comprising an orifice adapted to determine a controlled gas flow depending on the pressure p_{Uf}, the orifice having a preset diameter D and length L such that L<20−D, wherein the diameter D and the length L are further dimensioned in such a manner that the equivalent diameter Dₑ of the orifice is Dₑ≦100 nm, where Dₑ is defined by the relation Dₑ=D−a^{1/2} wherein a is the transmission probability of the orifice.

2. A reference leakage device according to claim 1, wherein the membrane comprises ceramic, metal, semiconductor material or a combination of such materials.

3. A reference leakage device according to claim 2, wherein the orifice is obtained through milling by means of focused ion beam.

4. A reference leakage device according to claim 1, comprising a plurality of orifices.

5. A method for manufacturing a reference leakage device for use in leakage detection of gas, method comprising:
preparing a membrane comprising a ceramic, metal, semiconductor material or a combination thereof, the membrane being adapted to be interposed between two environments having respective pressures pᵤ and pa, where pᵤ [symbol] p_{d}; and subjecting the membrane to a focused ion beam to form an orifice adapted to determine a controlled gas flow depending on the pressure pᵤ, the orifice having a desired diameter D and length L such that L<20−D, and that the equivalent diameter Dₑ of the orifice is Dₑ≦100 nm, where Dₑ is defined by the relation Dₑ=D−(a)^{1/2} wherein a is the transmission probability of the orifice.
